(19) United States
(12) Patent Application Publication
(10) Pub. No.: US 2012/0080414 A1
(43) Pub. Date: Apr. 5, 2012

(54) METHOD AND SYSTEM FOR LASER PATTERNING A SEMICONDUCTOR SUBSTRATE

(75) Inventors: Wenwu Zhang, Schenectady, NY (US); Christopher James Kapusta, Delanson, NY (US); Floribertus P. M. Heukensfeldt Jansen, Ballston Lake, NY (US); Kristian William Andreini, Burnt Hills, NY (US); Vladimir A. Lobastov, Clifton Park, NY (US); Kristen Ann Wangerin, Niskayuna, NY (US); Jun Cui, Richland, WA (US)

(73) Assignee: GENERAL ELECTRIC COMPANY, SCHENECTADY, NY (US)

(21) Appl. No.: 12/894,416

(22) Filed: Sep. 30, 2010

(51) Int. Cl. B23K 26/00

(52) U.S. Cl. 219/121.69

(57) ABSTRACT

A method for laser patterning a sample is presented. The method includes coating at least one side of a substrate to form a sample, where coating the at least one side of the substrate forms an interface between the coating and the at least one side of the substrate. Further, the method includes configuring a scanning pattern for patterning the sample. In addition, the method includes determining settings for one or more laser beams of a laser based on the configured scanning pattern. Moreover, the method includes focusing the one or more laser beams of the laser at or near a surface of the substrate by selecting a focal point of the one or more laser beams near the surface of the substrate and setting a scribe depth near the surface of the substrate. The method also includes patterning the sample based on the configured scanning pattern using the one or more laser beams to generate one or more pixelated devices from the sample.

### BACKGROUND

Embodiments of the present invention relate to patterning samples, and more particularly to laser patterning electrodes on semiconductor substrates.

Radiation detectors, capable of detecting X-rays and gamma rays, have been developed over the years for a variety of applications, such as, but not limited to, medical imaging and detection, non-destructive testing and security inspection. Cadmium Zinc Telluride CdZnTe (CZT), and particularly Cd₍₁₋ₓ₎Zn₍ₓ₎Te (where x is less than or equal 0.5), is a wide bandgap ternary II-VI compound semiconductor that finds application in radiation detectors because of its unique electronic properties. Particularly, CZT detectors are of great interest as these detectors are capable of providing high-resolution X-ray and gamma ray spectra at room temperature due to the high atomic numbers of Cd and Te and the favorable electronic band structure. Furthermore, CZT can operate in a direct-conversion mode at room temperature without liquid nitrogen cooling. Additionally, CZT can be formed into a wide variety of shapes for different radiation-detecting applications. A variety of electrode geometries, such as coplanar grids, have been developed to provide unipolar operation, thereby improving energy resolution. Moreover, CZT detectors are relatively low cost, high-resolution detectors.

Generally, for proper operation, CZT devices typically need two conductive electrodes applied to their surface to permit charge collection from the detector. Traditionally, commercial pixelated or segmented CZT devices have been patterned by conventional techniques such as photolithography and shadow masking. Patterning by photolithography involves numerous steps, including film deposition, photoresist (PR) coating, PR baking, exposure, developing, material etching and PR stripping. This complex process requires a large investment in equipment, high fabrication costs, high maintenance charges, large volumes of chemicals, and long fabrication times. Another drawback with photolithography is that it is poorly suited for patterning non-planar surfaces and provides no control over the chemistry of the surface.

Further, in shadow masking, a shadow mask is applied on a substrate, and then a film is deposited over the mask. The shadow mask is then removed to provide a pixelated device. Unfortunately, in this method of patterning, it is hard to maintain a small distance between the mask and the substrate without damaging the surface of the substrate. Additionally, shadow masks have relatively poor feature resolution.

Moreover, CZT is a soft and brittle crystalline material. Accordingly, it may be desirable to develop a robust technique and system for generating a pixelated CZT device that minimizes the risk of damage to the CZT substrate. In addition, there is also a need for a method that minimizes the number of processing steps by circumventing post treatment of the CZT substrate. There is a further need to develop a CZT device with a high interpixel resistivity and accurately placed electrode features.

### BRIEF DESCRIPTION

In accordance with aspects of the present technique, a method for laser patterning a sample is presented. The method includes coating at least one side of a substrate to form a sample, where coating the at least one side of the substrate forms an interface between the coating and the at least one side of the substrate. Further, the method includes configuring a scanning pattern for patterning the sample. In addition, the method includes determining settings for one or more laser beams of a laser based on the configured scanning pattern. Moreover, the method includes focusing the one or more laser beams of the laser at or near a surface of the substrate by selecting a focal point of the one or more laser beams near the surface of the substrate and setting a scribe depth near the surface of the substrate. The method also includes patterning the sample based on the configured scanning pattern using the one or more laser beams to generate one or more pixelated devices from the sample.

In accordance with another aspect of the present technique, a system for laser patterning a sample is presented. The system includes a laser generator configured to generate one or more laser beams. Additionally, the system includes a motion controller configured to control a relative motion between the one or more laser beams and the sample, wherein the sample comprises a coating disposed on at least one side of a substrate, and wherein a portion of the coating forms an interface between the coating and the at least one side of the substrate. The system also includes an optical subsystem configured to direct the one or more laser beams at the sample, wherein the optical subsystem is operatively coupled to the laser generator, the motion controller, or both the optical subsystem and the motion controller. Furthermore, the system includes a central control unit operatively coupled to the motion controller and configured to configure a scanning pattern for patterning the sample, determine settings for the one or more laser beams of the laser based on the configured scanning pattern, focus the one or more laser beams of the laser at the surface of the substrate of the sample by selecting a focal point of the one or more laser beams near the surface of the substrate, and setting a scribe depth near the surface of the substrate. Furthermore, the central control unit is configured to pattern the sample based on the configured scanning pattern using the one or more laser beams to generate one or more pixelated devices from the sample.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a laser patterning system, in accordance with aspects of the present technique;

FIG. 2 is a flow chart illustrating an exemplary method for laser patterning a sample, in accordance with aspects of the present technique;

FIG. 3 is a diagrammatic illustration of the exemplary method for laser patterning the sample of FIG. 2, in accordance with aspects of the present technique;

FIG. 4 is a diagrammatic illustration of one embodiment of a sample that includes a semiconductor substrate having a coating disposed on at least one side, in accordance with aspects of the present technique;

FIG. 5 is a diagrammatic illustration of an alternative embodiment of a sample that includes a semiconductor substrate having a coating disposed on at least one side, in accordance with aspects of the present technique;

FIGS. 6-8 are diagrammatic illustrations of different embodiments of scanning patterns, in accordance with aspects of the present technique;

FIG. 9 is a diagrammatic illustration of an exemplary method of focusing the one or more laser beams on a sample, in accordance with aspects of the present technique;

FIG. 10 is a diagrammatic illustration of translating the sample, in accordance with aspects of the present technique;

FIG. 11 is a diagrammatic illustration of the method for patterning the sample using one or more laser beams, in accordance with aspects of the present technique; and

FIG. 12 is a diagrammatic illustration of a pixelated device formed employing the exemplary method for laser patterning the sample of FIG. 2, in accordance with aspects of the present technique.

### DETAILED DESCRIPTION

As will be described in detail hereinafter, a system and method for laser patterning a sample, such as semiconductor substrate are presented. By employing the method and system described hereinafter, a pixelated device having enhanced performance may be obtained. Furthermore, the method for laser patterning the sample to generate a pixelated device with enhanced performance described hereinafter presents a simplified process for pixellating a sample. Additionally, the method presents a simplified process and enhances flexibility while processing the sample.

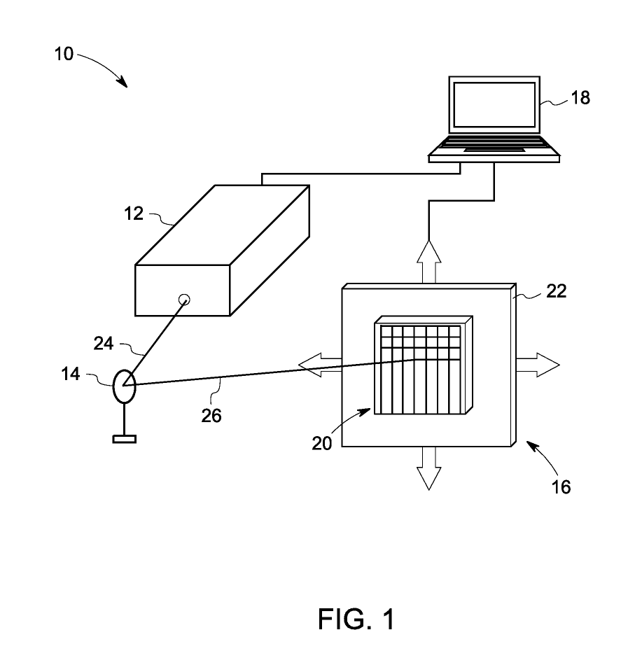

FIG. 1 illustrates one embodiment of a laser patterning system 10 that incorporates aspects of the present invention. In a presently contemplated configuration, the laser patterning system 10 includes a laser generator 12, an optical subsystem 14, a motion controller 16, and a central control unit 18. Furthermore, the laser patterning system 10 includes a stage 22 that supports a sample 20 to be patterned. In accordance with exemplary aspects of the present technique, the sample 20 includes a semiconductor substrate (not shown in FIG. 1). Particularly, the sample 20 includes a semiconductor substrate having a coating (not shown in FIG. 1) disposed on at least one side of the semiconductor substrate. The semiconductor substrate may include a CZT substrate, in certain embodiments. Also, the coating may include a metal, an alloy, a non-metallic conductor, or a combination thereof. It is further to be appreciated that coatings may be applied to more than one surface of the semiconductor substrate.

The laser generator 12 generates one or more laser beams 24. These one or more laser beams 24 are employed to pattern the sample 20. In certain embodiments, the one or more laser beams 24 may include pulsed laser beams with a duty cycle less than 1%. By way of example, the one or more laser beams may include ultraviolet laser beams, nanosecond laser beams, picosecond laser beams, or femtosecond laser beams. In addition, the intensity profiles of the one or more laser beams 24 may include a Gaussian intensity profile, a knife intensity profile or a top-hat intensity profile. It may be noted that use of other types of laser beams is also contemplated in accordance with aspects of the present technique.

Moreover, the optical subsystem 14 is operatively coupled to the laser generator 12. Also, the optical subsystem 14 directs the one or more laser beams 24 generated by the laser generator 12 onto the sample 20. These one or more laser beams 24 that are directed towards the sample 20 by the optical subsystem 14 may generally be represented by reference numeral 26. In certain embodiments, the optical subsystem 14 may include a focusing unit (not shown in FIG. 1) configured to focus the one or more laser beams 24 generated by the laser generator 12 at the surface of the sample 20. Also, in certain embodiments, the focusing unit may include a scanning-based unit or a lens-based unit. Furthermore, the optical subsystem 14 may include mirrors, lenses, gratings, prisms, fibers, waveguides, or combinations thereof to aid in focusing the one or more laser beams 26 onto the surface of the sample 20.

In addition, the motion controller 16 is operatively coupled to the optical subsystem 14, as depicted in FIG. 1. The motion controller 16 controls a relative motion between the one or more laser beams 26 and the sample 20 to aid in the patterning of the sample 20. Particularly, the motion controller 16 controls the motion of the stage 22. In one embodiment, the motion controller 16 may translate the stage 22 that supports the sample 20 to facilitate the laser patterning of the sample 20, while the one or more laser beams 26 are held stationary. In certain other embodiments, while the one or more laser beams 26 are held in a stationary position, the motion controller 16 may translate the stage 22 that supports the sample 20 to facilitate the laser patterning of the sample 20. However, in other embodiments, the motion controller 16 may translate the stage 22 along with the sample 20, while the one or more laser beams 26 are also moved to pattern the sample 20. The one or more laser beams 26 may be moved via use of a galvanometer scanner system (not shown in FIG. 1), in certain embodiments. It may be noted that in certain embodiments, the motion controller 16 translates the stage 22 that supports the sample 20 based on a speed determined by the central control unit 18.

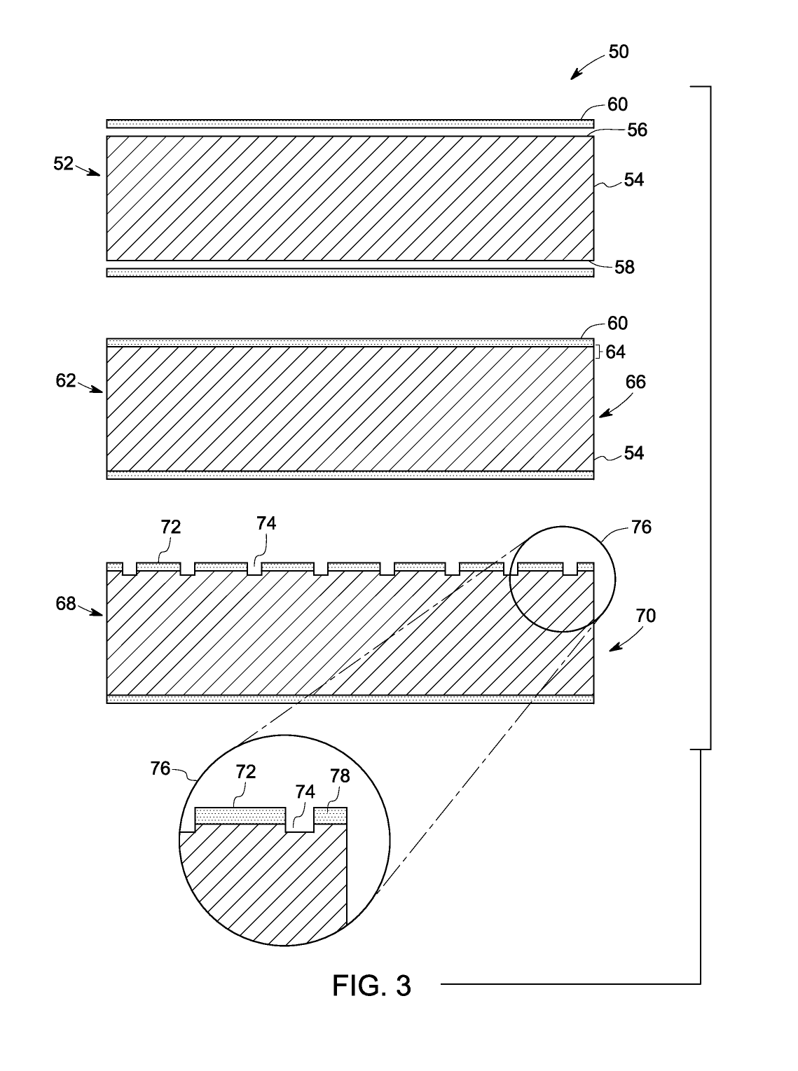

Furthermore, as noted hereinabove, the optical subsystem 14 directs the one or more laser beams 24 generated by the laser generator 12 to the surface of the sample 20. In accordance with aspects of the present technique, the sample 20 includes a semiconductor substrate (not shown in FIG. 1, see FIG. 3), such as a CZT substrate, having a coating disposed on at least one side. Additionally, in one embodiment, a surface of the semiconductor substrate such as the at least one side of the semiconductor substrate may be prepared prior to forming a coating on the at least one side of the substrate. By way of example, the surface of the semiconductor substrate may be prepared such that the surface of the semiconductor substrate is about 5 nm for a 50 μm×50 μm area. The surface preparation may entail mechanical polishing or chemical-mechanical polishing, ion milling, etching, and the like.

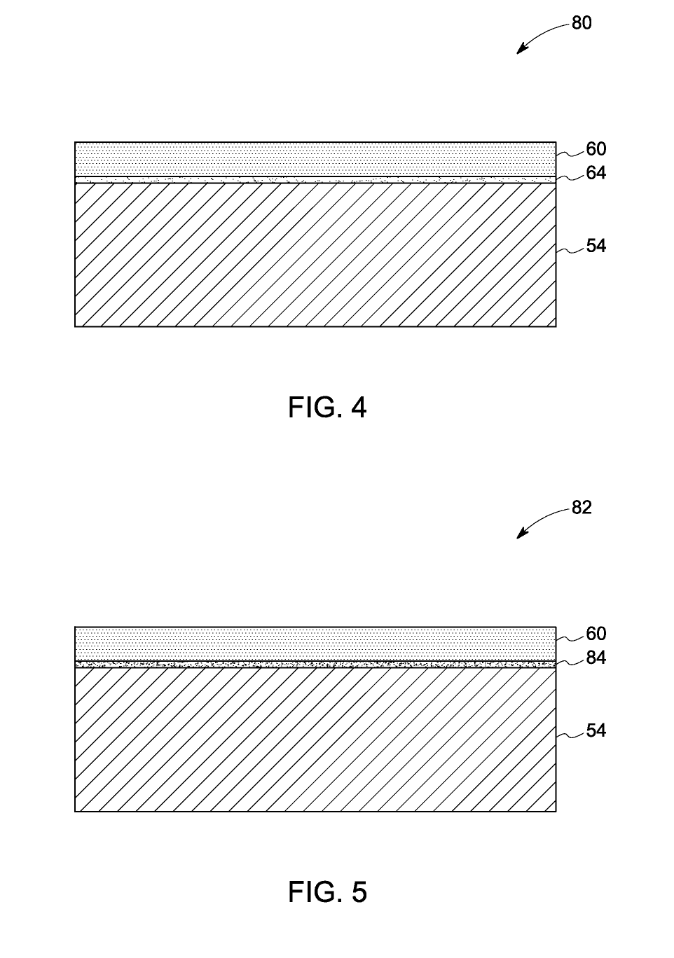

Once the surface is prepared, a coating (not shown in FIG. 1, see FIG. 3) is formed on the at least one side of the semiconductor substrate. The coating may include a thin film of a metal, such as gold, in certain embodiments. Also, this coating forms an interface between the coating and the at least one side of the semiconductor substrate that the coating is deposited on. However, in certain other embodiments, a diffusion barrier (not shown in FIG. 1, see FIG. 4) may be formed between the coating and at least one side of the semiconductor substrate 20. In this embodiment, the diffusion barrier acts as an interface between the coating and the semiconductor substrate. In certain other embodiments, diffusion of the coating material into the substrate material may take place so that an intermediate layer is created which affects the electronic properties of a detector.

The laser patterning system 10 also includes the central control unit 18 that is operationally associated with the laser generator 12. In some embodiments, the central control unit 18 is also operatively coupled to the motion controller 16. In one embodiment, the central control unit 18 controls the patterning of the sample 20. Particularly, in accordance with aspects of the present technique, the central control unit 18 facilitates patterning of the sample 20 using the one or more laser beams 26 by controlling the one or more laser beams 26 based on a determined scanning pattern and/or determined settings of the one or more laser beams 26. To that end, the central control unit 18 is configured to determine and execute a scanning pattern for patterning the sample 20 based on a desired configuration of a pixelated device that is formed subsequent to the laser patterning of the sample 20. As used herein, the term scanning pattern is used to refer to a desired pattern of one or more pixels in a pixelated device. In particular, the scanning pattern includes one or more pixels, one or more roads, a guard ring, or combinations thereof. It may also be noted that in accordance with aspects of the present technique, the sample 20 is patterned by the one or more laser beams 26 based on the configured scanning pattern. Specifically, the configured scanning pattern is used as a template for the one or more laser beams 26 for patterning the sample 20. Also, as used herein, the term one or more roads is used to refer to a separation between the one or more pixels. Moreover, the guard ring aids in capturing leakage current along edges of the device. Although the scanning pattern is described as including one or more pixels, one or more roads, a guard ring, or combinations thereof, it will be appreciated that use of other scanning patterns and/or geometries are also contemplated in accordance with aspects of the present technique.

The central control unit 18 determines settings corresponding to the one or more laser beams 26. Specifically, the settings of the one or more laser beams 26 are determined such that the configured scanning pattern may be patterned on the sample 20 to form the pixelated device. The settings of the one or more laser beams may include a desired overlap, a desired power, and/or a spot size, a pulse energy, a desired scan speed of the one or more laser beams 26 to pattern the sample 20 based on the configured scanning pattern.

Accordingly, the central control unit 18 determines the desired overlap of the one or more laser beams 26, the desired power of the one or more laser beams, and the spot size of the one or more laser beams 26. In certain embodiments, the desired power is determined by determining a pulse duration, a repetition rate, and individual pulse energy. Also, in one embodiment, the desired average power may be about 10 mW, in certain embodiments. Moreover, in some embodiments, the desired spot overlap of the one or more laser beams 26 may be in a range from about 50% to about 95%. The pulse energy of the one or more laser beams 26 may be in a range from about 10 micro joules to about 50 micro joules. The energy is determined by the power and pulse duration. The average power may be at least 10 mW, in certain embodiments. The one or more laser beams 26 may have a pulse duration of less than about 10 nanoseconds. The one or more laser beams 26 may also have a wavelength less than about 850 nm, focused laser intensity greater than about 0.2 GW/cm², and a focused spot size less than about 60 microns.

Additionally, the central control unit 18 determines a repetition rate of the one or more laser beams 26 to aid in determining the desired the desired power. In one embodiment, the one or more laser beams 26 may have a repetition rate greater than about 1 kHz. By way of example, the repetition rate of the one or more laser beams 26 may be in a range from about 1 kHz to about 1 MHz. Additionally, determining the desired spot overlap includes determining a scan speed of the one or more laser beams for achieving the desired overlap. Particularly, the desired scan speed of the one or more laser beams for achieving the desired overlap is determined based on the desired spot size and the repetition rate. In one embodiment, the spot overlap ratio may have an overlap greater than about 50%. Furthermore, in some embodiments, the optical subsystem 14 modifies the one or more laser beams 24 generated by the laser generator 12 to generate the one or more laser beams 26 based on the determined settings.

Once the scanning pattern is configured and the settings corresponding to the one or more laser beams 26 are determined, in accordance with aspects of the present technique, the central control unit 18 focuses the one or more laser beams 26 to initiate patterning of the sample 20 based upon the configured scanning pattern. Particularly, the central control unit 18 selects a focal point for each of the one or more laser beams 26 at or near a surface of the sample 20. In certain embodiments, the focal point is selected to be in a range from about 0 μm to about 20 μm near the surface of the sample 20. By way of example, the focal point is selected to be in a range from about 0 μm to about 20 μm below the surface of the sample 20.

Moreover, the central control unit 18 also controls the scribing of the sample 20 using the one or more laser beams 26. It may be noted that the in one embodiment, the central control unit 18 controls the scribing of the sample 20 with our without the usage of the stage 22. In certain embodiments, scribing the sample 20 using the one or more laser beams 26 entails ablating the sample 20 based on the configured scanning pattern. The terms scribing and ablating may be used interchangeably. As will be appreciated, the surface of the sample 20 is typically brittle. Hence, scribing the surface of the sample 20 with a laser beam generally damages the brittle surface of the sample 20. In accordance with exemplary aspects of the present technique, damage to the surface of the sample 20 during the laser patterning process may be circumvented by setting a scribe depth near the surface of the sample 20. Particularly, the laser power that can still fully ablate the coating 60 and achieve high interpixel resistivity may be reduced by setting the scribe depth near the surface of the sample 20. As used herein, the term scribe depth is used to refer to a depth near the surface of the sample 20 at which the one or laser beams 26 are configured to scribe the sample 20 based on the configured scanning pattern. Accordingly, the central control unit 18 sets the scribe depth near the surface of the sample 20. In certain embodiments, the scribe depth is in a range from about 1 nm to about 20 μm below the interface layer of the sample 20. Additionally, in some embodiments, the scribe depth may be selected to be in a range from about 1 nm to about 1000 nm greater than a thickness of the interface layer.

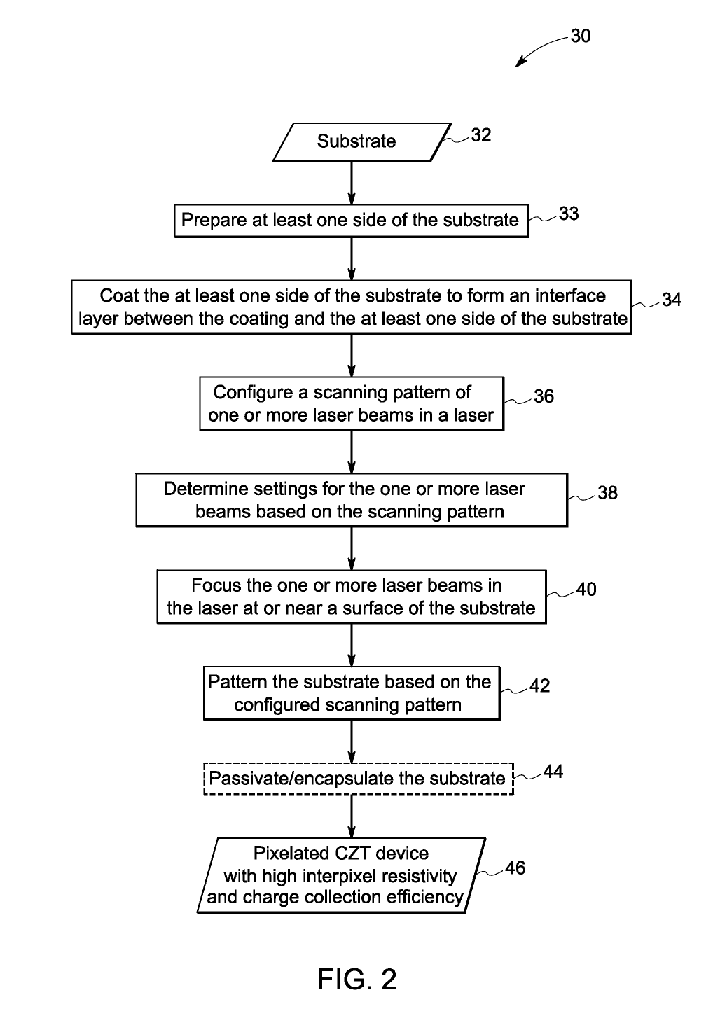

The central control unit 18 also facilitates the patterning of the sample 20 based on the configured scanning pattern and the determined settings to generate one or more pixelated devices from the sample 20. It may further be noted that patterning the sample 20 may entail multiple passes with a position offset of the one or more laser beams 26 to obtain the desired width of the roads. The operation of the laser patterning system 10 will be explained in greater detail with reference to FIGS. 2-12.

Turning now to FIG. 2, a flow chart 30 illustrating an exemplary method for laser patterning a sample, such as the sample 20 of FIG. 1, is depicted. Typically, a semiconductor substrate 32, such as a CZT substrate, has a first side and a second side. In certain embodiments, at least one side of the substrate 32 may be prepared prior to coating, as indicated by optional step 33. As previously noted, the surface preparation of step 33 may entail mechanical polishing or chemical-mechanical polishing, ion milling, etching, and the like. Subsequently, at step 34, at least one side of the semiconductor substrate 32 is coated with a coating to form an interface between the at least one side of the semiconductor substrate 32 and the coating. Step 34 may be better understood with reference to FIG. 3.

Referring now to FIG. 3, a diagrammatic representation 50 of the exemplary method for laser patterning is depicted. A semiconductor substrate 54, such as the substrate 32 of FIG. 2, is depicted as including a first side 56 and a second side 58. At step 52, a coating 60 is formed on at least one side of the semiconductor substrate 54. In the depicted embodiment, the coating 60 is formed on the first side 56 of the semiconductor substrate 54. It may be noted that in certain other embodiments, a coating may instead be formed on the second side 58 of the substrate 54. In yet another embodiment, a coating may be formed on each of the first side 56 and the second side 58 of the semiconductor substrate 54. In one embodiment, the coating 60 may include a metal. In a presently contemplated configuration, the coating 60 is a gold coating. However, in other embodiments, metals, such as, but not limited to, Ni, V, W, Ti, Al, Cu, Pt, Pd, In, Mo, as well as other transition metals may be used. In another embodiment, the coating 60 may include an alloy, such as, but not limited to, TiW and NiV. The coating 60 may include a conductive layer. By way of example, the coating 60 may include a conductive layer that includes non-metallic elements. In yet another embodiment, the coating 60 may include a combination of a metal, an alloy and a conductive layer. Also, the coating 60 may have a thickness in a range from about 10 nm to about 5 μm.

Furthermore, as illustrated by step 62, the coating 60 is formed on the at least one side 56 of the semiconductor substrate 54 such that an interface layer 64 is formed between the coating 60 and the at least one side 56 of the semiconductor substrate 54. The semiconductor substrate 54 having the coating 60 disposed thereon may be referred to as a sample and may be generally be referenced by reference numeral 66. Particularly, a portion of the coating 60 formed on the least one side 56 of the semiconductor substrate 54 may diffuse into the semiconductor substrate 54, thereby creating the “interface” layer 64. It may be noted that the diffusion of the coating 60 into the semiconductor substrate 54 is dependent upon the material used in the coating 60. Also, this interface layer 64 may be conductive. Here again, the extent of conductivity of the interface layer 64 is dependent upon the material used in the coating 60. Moreover, the interface layer 64 may have a thickness in a range from about 0.1 nm to about 20 μm.

FIG. 4 depicts a further embodiment 80 of the sample 66 of FIG. 3. In particular, the sample 80 includes the semiconductor substrate 54 and the coating 60 disposed thereon such that the interface layer 64 is formed therebetween.

It may also be noted that in certain other embodiments, a diffusion barrier 84 may be formed between the coating 60 and the semiconductor substrate 54 to form the sample to be patterned. FIG. 5 illustrates an alternative embodiment 82 of the sample 66 where the diffusion barrier 84 is formed between the coating 60 and the semiconductor substrate 54. In this embodiment, the diffusion barrier 84 is representative of an interface layer, such as the interface layer 64 (see FIG. 4). The diffusion barrier 84 may be formed using TiW, for example. Also, the diffusion barrier 84 may have a thickness in a range from about 1 nm to 10 μm.

With returning reference to FIG. 2, once the sample 66 to be patterned is formed with a coating 60 on the at least one side 56 of the semiconductor substrate 54, a scanning pattern may be configured, as depicted by step 36. As previously noted, the scanning pattern is generally representative of a pattern of one or more pixels, one or more roads, a guard ring, or combinations thereof, and is generally indicative of a desired pattern to be scribed on the sample to form a desired pixelated device. Furthermore, as previously noted, the scanning pattern is based on a desired resolution of a pixelated device and/or a thickness of a device. Particularly, if a higher resolution of the pixelated device is desired, pixels of relatively smaller size may be formed. Alternatively, if a lower resolution of the pixelated device is desired, pixels of relatively larger size may be formed.

It may be noted that the pixel geometry is determined based on a desired spatial and energy resolution. Additionally, the pixel geometry is also dependent upon the quantity and complexity of electronics required to connect to each pixel. It may be noted that a device with a smaller ratio of pixel size to substrate thickness and a small gap between pixels is generally a better performing semiconductor device.

Additionally, it may be desirable to include a guard ring in the scanning pattern. The guard ring prevents degradation of the radiation detection performance of edge pixels. This degradation typically occurs due to surface leakage. In one embodiment, the guard ring may be disposed at a distance in a range from about 10 μm to about 100 μm from the edge of the pixelated device. Moreover, in accordance with aspects of the present technique, pixel dimensions, the width of the roads, and pixel distance to edge with guard ring are optimized for charge collection efficiency, including photopeak fraction. It may further be noted that in certain embodiments guard rings may be placed at both surfaces of the semiconductor surface 54. By way of example, the guard rings may be placed at a first surface (anode surface) and a second surface (cathode surface) of the semiconductor substrate 54.

In certain other embodiments, the scanning pattern may not include a guard ring. Particularly, the scanning pattern may include one or more pixels to the edge of the semiconductor substrate 54. Once the size of the one or more pixels, the size of the one or more roads, and the inclusion or exclusion of the guard ring are determined, the scanning pattern is configured. The scanning pattern so configured may then be employed to scribe the sample using the one or more laser beams.

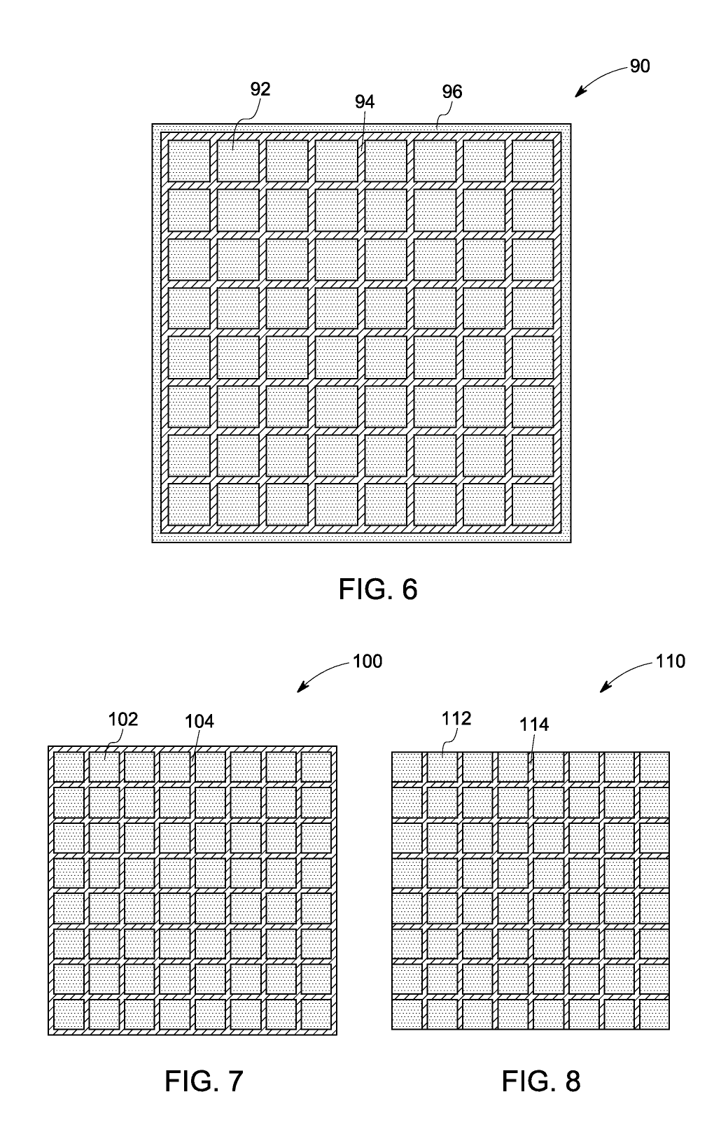

FIGS. 6-8 illustrate different embodiments of scanning patterns that may be configured at step 36. Referring now to FIG. 6, a first embodiment 90 of a scanning pattern is depicted. In this embodiment, the scanning pattern 90 includes one or more pixels 92. In addition, the scanning pattern 90 also includes one or more roads 94 that separate the one or more pixels 92. As noted hereinabove, the size of the one or more pixels 92 is dependent upon a desired design or performance of the pixelated device. The width of the one or more roads 94 may be selected to be as small as possible while still achieving relatively good interpixel resistivity. Additionally, in the embodiment illustrated in FIG. 6, a guard ring 96 is included. As previously noted, the guard ring 96 prevents any leakage of charge from the one or more pixels 92.

Furthermore, a second embodiment 100 of a scanning pattern is depicted in FIG. 7. This embodiment includes one or more pixels 102 and one or more roads 104 that separate the one or more pixels 102. However, the scanning pattern of FIG. 7 does not include a guard ring. Also, a third embodiment 110 illustrated in FIG. 8 is shown as including one or more pixels 112 separated by one or more roads 114, where the one or more pixels 112 are arranged up to an edge of the pixelated device.

Referring again to FIG. 2, once the scanning pattern is configured, settings of the one or more laser beams are determined, as indicated by step 38. In particular, the settings of the one or more laser beams 26 are determined based on the scanning pattern configured at step 36. In accordance with aspects of the present technique, it may be noted that for laser patterning the sample, and more particularly the thin metal film coating that is formed on the brittle crystalline semiconductor substrate, it is desirable to satisfy several requirements to ensure qualified machining. By way of example, to achieve a qualified machining, it may be desirable to ensure a clean and complete removal of the thin metal film coating. Additionally, it may also be desirable to avoid over-machining of the semiconductor substrate and to ensure complete ablation of the metal file coating without residual thermal damage to the metal film coating and the semiconductor substrate.

Accordingly, to facilitate qualified machining, settings corresponding to the one or more laser beams 26 may be determined. As previously noted, the settings of the one or more laser beams 26 are typically determined based on the scanning pattern configured at step 36. Also, in certain embodiments, the settings of the one or more laser beams 26 may include a power, a pulse rate, a scan speed, laser pulse width, laser pulse energy, repetition rate, a focal spot size, an overlap ratio of the one or more laser beams, or other factors that affect machining quality. In one embodiment, ultrashort pulsed lasers may be employed. As used herein, the term ultrashort pulsed lasers is used to refer to lasers that are typically less than 1 ns. In certain embodiments, a laser having a duration in a range from about 50 femtoseconds to about 350 femtoseconds and having a wavelength of about 800 nm laser may be employed.

Furthermore, the laser pulse energy may be lowered to a value near 50 micro joules. In one embodiment, the laser pulse energy may be lowered to a value between about 5 micro joules and about 50 micro joules. The laser pulse energy may be lowered using an external laser energy modulator (not shown), where the external energy modulator includes a quarter waveplate and a polarizer that can change laser light energy without affecting the laser cavity stability. Moreover, laser focus may be set to a value near 50 microns. Also, an overlap ratio of the one or more laser beams may be selected in a range from about 50% to about 95%. Although the present technique is described using a laser having a pulse width less than about 1 ns, other nanosecond lasers may also be employed to pattern the sample 66. In accordance with further aspects of the present technique, a top-hat laser beam may be optionally employed to achieve a flat machining contour.

Moreover, the scan speed of the one or more laser beams 26 is determined based on an overlap percentage of the one or more laser beams 26, a focal spot size of the one or more laser beams 26 and a laser repetition rate. The focal spot size of the one or more laser beams 26 is representative of a scribe width of the one or more laser beams. By way of example, in one embodiment, the scan speed v may be determined using the following relation:

v=f*(1−r)*D (1)

where f is the repetition rate, r is the overlap percentage, and D is the diameter of the focal spot size.

By way of example, if the focal spot size has a diameter of 30 μm, the repetition rate is 1000 Hz, and the overlap percentage is 60%, then the scan speed is 12 mm/second. It may be noted that based on the desired overlap percentage, the scan speed of the one or more laser beams may be varied.

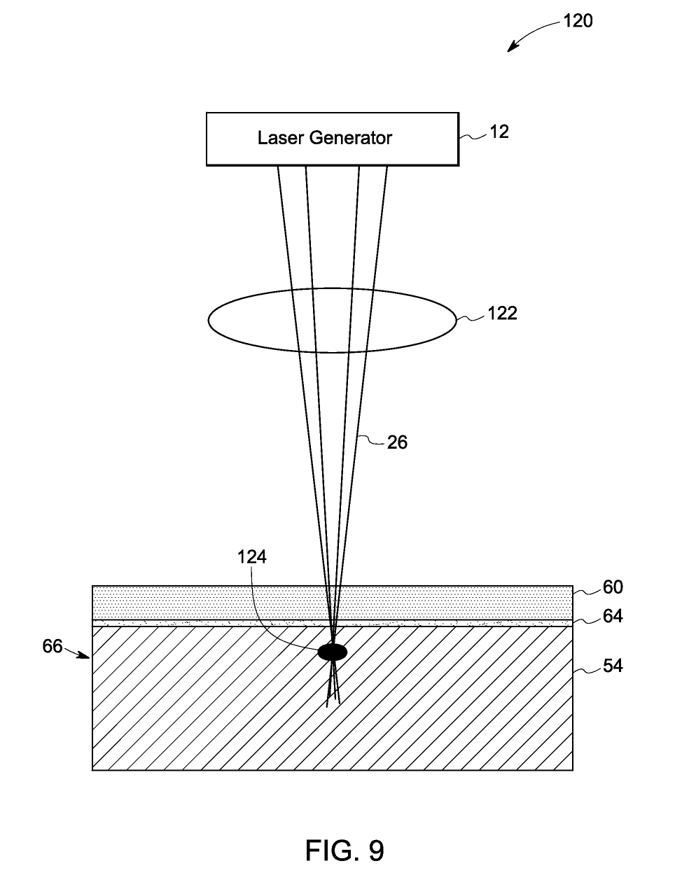

As previously noted, focusing the laser beams on the surface of the semiconductor substrate damages the brittle semiconductor substrate. In accordance with exemplary aspects of the present technique, the one or more laser beams are focused away from the brittle surface of the semiconductor substrate, thereby circumventing damage to the surface of the semiconductor substrate 54 due to intense machining at the center of the semiconductor substrate 54. Accordingly, at step 40, the one or more laser beams are focused away from the surface of the semiconductor substrate 54 and instead focused near the brittle surface of the semiconductor substrate 54. Particularly, the one or more laser beams, such as the one or more laser beams 26 (see FIG. 1) are focused near the surface of the semiconductor substrate 54 by selecting a focal point of the one or more laser beams near the surface of the semiconductor substrate 54. In one embodiment, the focal point of the one or more laser beams may be selected such that the focal point is positioned below the surface of the semiconductor substrate in a range from about 10 nm to about 5 μm. The focusing of the one or more laser beams of step 40 may be better understood with reference to FIG. 9.

Turning now to FIG. 9, a diagrammatic representation 120 of the focusing of one or more laser beams near the surface of the semiconductor substrate 54 (see FIG. 3) is illustrated. As previously discussed, the laser generator 12 (see FIG. 1) generates one or more laser beams that are then directed onto the sample 20 (see FIG. 1) via the optical subsystem 14 (see FIG. 1). As depicted in FIG. 9, the one or more laser beams 26 are focused by selecting a focal point 124 of the one or more laser beams 26 such that the focal point 124 lies near the surface of the semiconductor substrate 54. In one embodiment, the focal point 124 of the one or more laser beams 26 may be selected to be positioned below the surface of the semiconductor substrate 54 in a range from about 10 nm to about 5 μm. Also, in certain embodiments, an optical device 122, such as a focusing lens, may optionally be employed to aid in focusing the one or more laser beams 26 such that the focal point 124 is at or near the surface of the semiconductor substrate 54. Additionally, at step 40, a scribe depth or an ablation depth is selected. As previously noted, the term scribe depth or ablation depth is used to refer to a depth near the surface of the semiconductor substrate 54 at which the one or more laser beams 26 scribe the semiconductor substrate 54.

By way of example, in the embodiment of the sample 80 (see FIG. 4), the scribe depth may be selected to be in a range from about 0 μm to about 1 μm below the bottom of the interface layer 64. Similarly, in the embodiment of the sample 82 (see FIG. 5), the scribe depth may be selected to be in a range from about 0 μm to about 1 μm near the bottom of the diffusion barrier 84.

Referring once again to FIG. 2, at step 42, the one or more laser beams, such as the one or more laser beams 26 (see FIG. 1) are employed to pattern the semiconductor substrate 54. Specifically, once the scanning pattern is configured and the laser settings are determined, the semiconductor substrate is patterned using the one or more laser beams based on the scanning pattern configured at step 36. In accordance with exemplary aspects of the present technique, the one or more laser beams 26 are employed to scribe the sample 66 to achieve a desired width of the roads, a desired interpixel resistivity, or a combination thereof. In some embodiments, the scribing of the sample 66 may entail a complete ablation of the coating 60. Also, in some other embodiments, the scribing of the sample 66 may additionally entail ablation of at least a portion of the semiconductor substrate 54. The patterning of the semiconductor substrate 54 using the one or more laser beams based on the configured scanning pattern may be better understood with reference to FIGS. 3 and 10-11.

As depicted in FIG. 3, and step 68 in particular, the one or more laser beams 26 are used to scribe the sample 66 based on the configured scanning pattern to form a pixelated device 70. Particularly, the one or more laser beams 26 that have been focused at step 40 are employed to scribe the desired scanning pattern on the sample 66 at the determined scribe depth. Reference numeral 72 is generally representative of one or more pixels that are formed subsequent to the patterning of the sample 66 by the one or more laser beams 26. In particular, the one or more roads are scribed such that the one or more roads separate the one or more pixels 72. These one or more roads are generally represented by reference numeral 74. This patterning of the one or more roads 74 facilitates interpixel isolation. Additionally, reference numeral 76 represents a portion of the pixelated device 70. The enlarged view of the portion 76 of the pixelated device illustrates the one or more pixels 72, the one or more roads 74 and a guard ring 78.

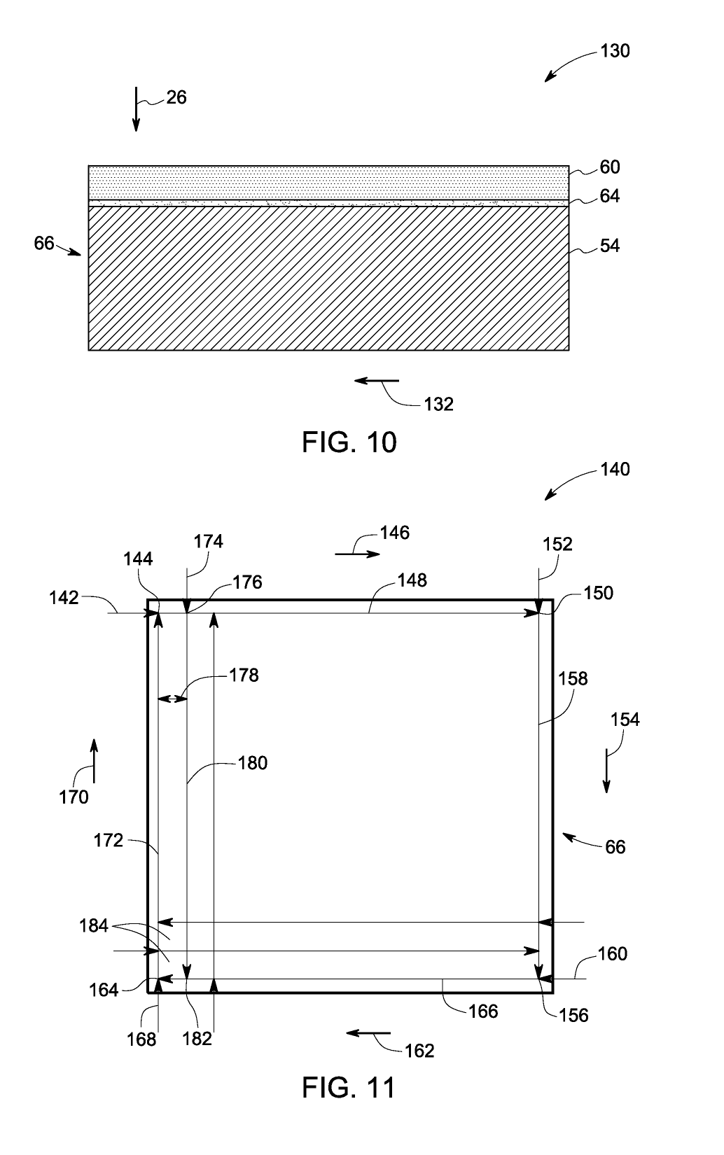

FIG. 10 depicts a diagrammatic illustration 130 of a method for patterning the semiconductor substrate based on the configured scanning pattern of step 42 (see FIG. 2). Particularly, FIG. 10 depicts a relative motion between the sample 66 (see FIG. 3) and the one or more laser beams 26 (see FIG. 1), where the relative motion aids in the patterning of the sample 66 based on the configured scanning pattern.

As illustrated in FIG. 10, the one or more laser beams 26 of the laser generated by the laser generator 12 (see FIG. 1) are impinged on the sample 66 via the optical subsystem 14 (see FIG. 1). As previously noted, the one or more laser beams 26 are focused near the surface of the semiconductor substrate 54. In one embodiment, the sample 66 that includes the semiconductor substrate 54 having the coating 60 disposed on at least one side of the semiconductor substrate 54 is translated along a first direction 132, while the one or more laser beams 26 generated by the laser generator 12 are held in a fixed position. By way of example, the sample 66 is mounted on the stage 22 (see FIG. 1) and the stage 22 may be translated in the first direction 132 via use of the motion controller 16 (see FIG. 1). Alternatively, in certain other embodiments, the sample 66 may be positioned in a fixed position, while the one or more laser beams 26 are translated in the first direction 132. However, in certain other embodiments, both the one or more laser beams 26 and the sample 66 may be translated such that while the sample 66 is translated in the first direction 132, the one or more laser beams 26 are translated in a second direction. In certain embodiments, the second direction may be substantially perpendicular to the first direction 132. Also, the sample 66 may be translated at a scan speed that is determined by the central control unit 18 (see FIG. 1). The patterning of the sample 66 may be better understood with reference to FIG. 11.

Referring now to FIG. 11, a diagrammatic illustration 140 of the patterning of the sample 66 (see FIG. 3) employing the one or more laser beams 26 (see FIG. 1) is depicted. In a presently contemplated configuration, the configured scanning pattern includes the scanning pattern illustrated in FIG. 6. Particularly, the scanning pattern includes the one or more pixels, one or more roads and a guard ring.

In accordance with aspects of the present technique, the patterning of the sample 66 entails translation of the sample 66. Particularly, the translation of the stage 22 supporting the sample 66 is initiated before energizing the laser generator. As depicted in FIG. 11, the translation of the sample 66 is initiated as indicated by reference numeral 142. Once the translation of the sample 66 is initiated, the laser generator 12 is energized. In particular, the laser generator 12 is energized at a position on the sample 66 indicated by reference numeral 144. Accordingly, the laser generator 12 is energized only after the translation of the sample 66 has been initiated. Specifically, the one or more laser beams 26 of the laser generated by the laser generator 12 are focused at the determined focal point near the surface of the sample 66 to aid in scribing the desired pattern on the sample 66. Energizing the laser generator only after the translation of the sample 66 has been initiated aids in ensuring a constant depth profile with the scribe and prevents drilling into the surface when the laser is energized and not moving at full speed. Multiple passes of the one or more laser beams may be necessary to ensure that the coating 60 on the semiconductor substrate 54 of the sample 66 is ablated in order to ensure that a desired interpixel resistivity is obtained.

The one or more laser beams 26 are focused at the determined focal point and are configured to scribe the sample 66 at the determined scribe depth as the sample 66 is translated in a first direction 146. Scribing the sample 66 at the determined scribe depth entails ablating the coating 60. The scribing process may also entail ablating a portion of the semiconductor substrate 54 of the sample 66. Reference numeral 148 is generally representative of a road scribed by the one or more laser beams 26 on the sample 66 in the first direction 146. The translation of the sample 66 is continued until a determined position, where the determined position is located at a determined distance from an edge of the sample 66. This determined position may generally be represented by reference numeral 150. It may be noted that in accordance with aspects of the present technique, machined material generated during the scribing of the sample 66 may be extracted. In one embodiment, a side vacuum may be used to extract the machined material. In other embodiments, an air knife may be used to blow off debris from the path of the one or more laser beams 26. Furthermore, the extracted machined material may be analyzed to check for presence of substrate matter. If substrate matter is detected in the extracted material, it may be confirmed that the desired scribing depth has been reached. This information may subsequently be used to adjust scribing parameters in real-time to obtain an optimal scribing profile.

Once the sample 66 is patterned till position 150 in the first direction 146, the scribing of the sample 66 is stopped. Subsequently, the translation of the sample 66 in a second direction 154 is initiated as indicated by reference numeral 152. Here again, the laser generator 12 is energized at the determined position 150, thereby avoiding cutting through the continuous guard ring that is formed around one or more pixels. Furthermore, in accordance with exemplary aspects of the present technique, starting and stopping the laser patterning at the numerous determined positions advantageously circumvents any overlap in the patterning of the sample 66. Specifically, no region on the sample 66 is scribed more than once, thereby avoiding scribing of the sample 66 beyond a desired depth. Accordingly, at any given position on the sample 66, if a road has previously been scribed, the laser generator 12 may be de-energized to prevent scribing the sample beyond the desired depth. The patterning of the sample 66 is continued along the second direction 154 until a determined position 156 is reached, where the scribing of the sample 66 is stopped. Reference numeral 158 is generally representative of the pattern (road) scribed by the one or more laser beams 26 on the sample 66 in the second direction 154.

Subsequently, the translation of the sample 66 in a third direction 162 is initiated and is generally represented by reference numeral 160. The laser generator 12 is energized at the position 156, thereby avoiding scribing of the guard ring. The patterning of the sample 66 is continued along the third direction 162 until a determined position 164 is reached, where the scribing of the sample 66 is stopped. Reference numeral 166 is generally representative of a pattern (road) scribed by the one or more laser beams 26 on the sample 66 in the third direction 162.

The patterning of the sample 66 is further continued by translating the sample 66 in a fourth direction 170. Reference numeral 168 is generally indicative of a translation of the sample in the fourth direction 170. Particularly, the sample 66 is patterned until the determined position 144 is reached. Reference numeral 172 is generally representative of a pattern (road) scribed by the one or more laser beams 26 on the sample 66 in the fourth direction 170.

Once the sample 66 is patterned along a periphery of the sample 66, the sample 66 may be further patterned based on the configured scanning pattern. Particularly, the sample 66 may be further patterned to form one or more pixels. Accordingly, the sample 66 is once again translated along the first direction 146 until a position on the sample 66 that is dependent upon the pixel size is reached. This distance may generally be represented by reference numeral 178. Subsequently, the sample 66 is translated in the second direction 154 until a determined position 176 is reached. This translation is generally represented by reference numeral 174. The laser generator 12 is energized at the determined position 176 to facilitate scribing a desired pattern 180 (road) along the second direction 154. The scribing is stopped at a determined position 182 to ensure that the road 166 is not scribed beyond a desired depth. By scribing the pattern 180, pixels 184 are formed. This process may be continued until all the roads have been scribed to form one or more pixels 184 in accordance with the scanning pattern configured at step 36.

With returning reference to FIG. 2, subsequent to patterning the sample 66 based on the configured scanning pattern, in certain embodiments, the patterned sample may optionally be coated with a passivation layer, as depicted by step 44. Coating the patterned sample with the passivation layer aids in encapsulating and passivating the sample. Following the steps 33-44 of the method of laser patterning the sample 66 that includes the semiconductor substrate 54 having a coating 60 disposed thereon, a pixelated device 46 is formed.

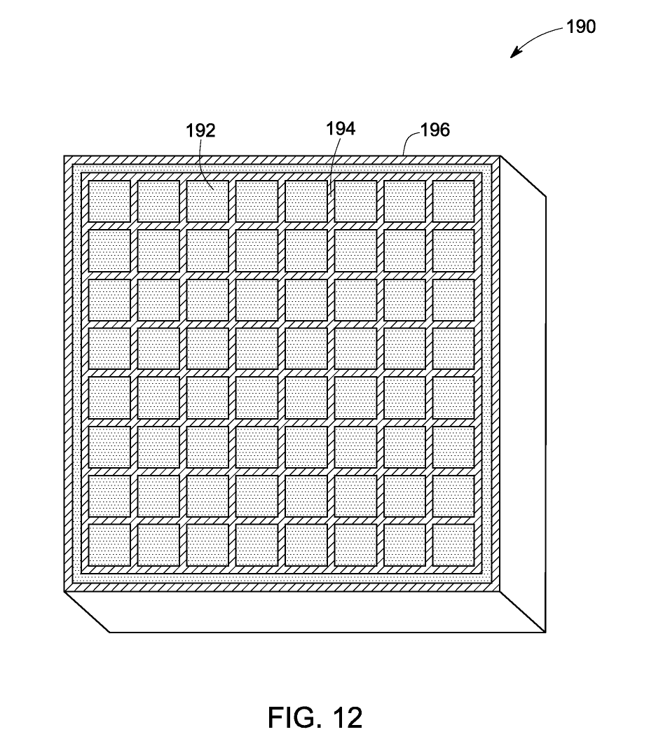

Turning now to FIG. 12, a perspective view 190 of a pixelated device, such as the pixelated device 46 (see FIG. 1) formed by patterning the sample 66 in accordance with exemplary aspects of the present technique, is depicted. One or more pixels are generally represented by reference numeral 192, while reference numeral 194 is representative of the one or more roads. Also, reference numeral 196 represents a guard ring.

The method and system described hereinabove advantageously facilitate higher accuracy, reproducibility, and flexibility for patterning semiconductor devices with desired road widths. Furthermore, the method for laser patterning allows high productivity and low labor intensity as well as low to moderate capital investment depending on the laser employed. Additionally, the exemplary method for laser patterning may be employed to pattern different materials as the method for laser patterning a sample is not material dependent.

Moreover, the exemplary method for laser patterning entails fewer processing steps compared to conventional photolithography patterning thereby substantially enhancing the speed of forming pixelated devices with enhanced performance. Additionally, interpixel isolation is formed as the one or more laser beams scribe the road, thereby circumventing the need for subsequent processing of the CZT substrate. Furthermore, the method and system for laser patterning presented hereinabove aids in generating a pixelated CZT device that minimizes the damage to the CZT substrate. The pixelated CZT device so formed exhibits a high interpixel resistivity and a high charge collection efficiency while minimizing pixel to pixel space.

Additionally, this method for laser patterning facilitates the manufacturing of devices with pixels of different shapes. By way of example, using this method, a device having square pixels, rectangular pixels, circular pixels, hexagonal pixels, or pixels of other shapes may be manufactured. Furthermore, devices including other electrode structures, such as interpixel grids, may also be manufactured. In certain embodiments, the interpixel grids are generally representative of a thin line between the pixels and are typically maintained at a slightly higher potential than the pixels. These interpixel grids provide “steering” of a charge cloud to a pixel.

1. A method for laser patterning a sample, comprising:
coating at least one side of a substrate to form a sample, wherein coating the at least one side of the substrate forms an interface between the coating and the at least one side of the substrate;
configuring a scanning pattern for patterning the sample;
determining settings for one or more laser beams of a laser based on the configured scanning pattern;
focusing the one or more laser beams of the laser at or near a surface of the substrate by:
selecting a focal point of the one or more laser beams near the surface of the substrate;
setting a scribe depth near the surface of the substrate; and
patterning the sample based on the configured scanning pattern using the one or more laser beams to generate one or more pixelated devices from the sample.

2. The method of claim 1, wherein the substrate comprises a semiconductor substrate.

3. The method of claim 1, further comprising preparing the at least one side of the substrate prior to coating the at least one side of the substrate.

4. The method of claim 1, wherein the one or more laser beams comprise pulsed laser beams with a duty cycle of less than about 1%.

5. The method of claim 1, wherein the one or more laser beams comprise a laser beam having a Gaussian intensity profile, a knife intensity profile, or a top-hat intensity profile.

6. The method of claim 1, wherein selecting the focal point of the one or more laser beams comprises selecting the focal point of the one or more laser beams in a range from about one nanometer to about one micron near the surface of the substrate.

7. The method of claim 1, wherein setting the scribe depth comprises selecting a scribe depth in a range of about one nanometer to about one micron near the surface of the substrate.

8. The method of claim 1, wherein coating the at least one side of the substrate comprises coating the at least one side of the substrate with a metal, an alloy, a conductive layer, or a combination thereof.

9. The method of claim 1, wherein the scanning pattern comprises one or more pixels, one or more roads, a guard ring, or combinations thereof.

10. The method of claim 1, wherein determining the settings of the one or more laser beams comprises:
determining a desired overlap of the one or more laser beams; and
determining a desired power of the one or more laser beams by determining a pulse duration, a repetition rate and individual pulse energy; and
determining a spot size of the one or more laser beams.

11. The method of claim 10, wherein the desired power is about 10 mW.

12. The method of claim 10, wherein the desired overlap of the one or more laser beams is in a range from about 50% to about 95%.

13. The method of claim 10, wherein determining the desired overlap comprises determining a scan speed of the one or more laser beams for achieving the desired overlap based on the desired spot size and the repetition rate.

14. The method of claim 13, wherein the pulse width of the one or more laser beams is less than about 100 ns.

15. The method of claim 13, wherein the repetition rate of the one or more laser beams is in a range from about 1 kHz to about 1 MHz.

16. The method of claim 13, wherein a pulse energy of the one or more laser beams is in a range from about 10 micro joules to about 50 micro joules.

17. The method of claim 13, further comprises multiple passes with a position offset of the one or more laser beams to obtain the desired width of the roads.

18. The method of claim 13, wherein patterning the sample based on the configured scanning pattern comprises translating the sample relative to the one or more laser beams.

19. The method of claim 18, wherein translating the sample relative to the one or more laser beams comprises initiating the translation of the sample prior to energizing the laser generator that generates the one or more laser beams.

20. The method of claim 19, further comprising energizing the laser generator that generates the one or more laser beams at determined positions on the sample to scribe the sample based on the configured scanning pattern.

21. The method of claim 20, further comprising scribing the sample based on the configured scanning pattern using the one or more laser beams to achieve a desired width of the roads with high interpixel resistivity.

22. The method of claim 21, further comprising stopping the patterning of the sample at determined positions on the sample to avoid scribing of the sample beyond a desired depth.

23. The method of claim 21, wherein scribing the sample forms interpixel isolation.

24. The method of claim 21, further comprising extracting machined material that is generated during the laser patterning of the sample.

25. The method of claim 24, further comprising:
analyzing the extracted machined material to detect presence of substrate matter; and
adjusting scribing parameters in real-time to obtain an optimal scribing profile based on the detected substrate matter.

26. The method of claim 25, further comprising coating the pixelated device with a passivation layer to passivate and encapsulate the one or more pixelated devices.

27. A system for laser patterning a sample, comprising:
a laser generator configured to generate one or more laser beams;
a motion controller configured to control a relative motion between the one or more laser beams and the sample, wherein the sample comprises a coating disposed on at least one side of a substrate, and wherein a portion of the coating forms an interface between the coating and the at least one side of the substrate;
an optical subsystem configured to direct the one or more laser beams at the sample, wherein the optical subsystem is operatively coupled to the laser generator, the motion controller, or both the optical subsystem and the motion controller;
a central control unit operatively coupled to the motion controller and configured to:
configure a scanning pattern for patterning the sample;
determine settings for the one or more laser beams of the laser based on the configured scanning pattern;
focus the one or more laser beams of the laser at or near the surface of the substrate of the sample by:
selecting a focal point of the one or more laser beams near the surface of the substrate;
setting a scribe depth near the surface of the substrate; and
pattern the sample based on the configured scanning pattern using the one or more laser beams to generate one or more pixelated devices from the sample.
